(19) United States
(12) Patent Application Publication
(10) Pub. No.: US 2014/0108183 A1
(43) Pub. Date: Apr. 17, 2014

(54) Task Exchange

(71) Applicant: Moose Loop Holdings, LLC, (US)

(72) Inventor: Ken R. Davis, Salt Lake City, UT (US)

(73) Assignee: Moose Loop Holdings, LLC, Salt Lake City, UT (US)

(21) Appl. No.: 13/838,472

(22) Filed: Mar. 15, 2013

Related U.S. Application Data
(60) Provisional application No. 61/697,099, filed on Sep. 5, 2012.

(51) Int. Cl. G06Q 30/06

(52) U.S. Cl. CPC G06Q 30/0611
USPC 705/26.4

(57) ABSTRACT

Technology is described for task exchange. The method can include obtaining a task definition for a task having task details to be performed for a customer. A task value can be set for the task based on the task details. The task can be offered for exchange via an electronic exchange interface. A further operation can be exchanging the task between a first party and a second party based on the task value.

### PRIORITY CLAIM

Priority is claimed to U.S. Provisional Patent Application Ser. No. 61/697,099, filed Sep. 5, 2012, which is hereby incorporated herein by reference in its entirety.

### BACKGROUND

Many goods can be purchased in a commoditized way. A consumer can have certain criteria when deciding to purchase a good and if the good meets the desired criteria, then the consumer generally does not care who provides the good.

Services have traditionally been less commoditized. Rather, services are typically purchased after comparing service providers to one another. For example, service providers can be compared through a bidding process, interviews, and/or online user feedback ratings. Even such service provider comparisons can be challenging for a consumer to interpret due to the non-uniformity in services supplied by various service providers. This has resulted in uncertainty to the consumer as to the comparative cost of services, reliability of services, and the quality of services provided by service providers.

### BRIEF DESCRIPTION OF THE DRAWINGS

FIG. 1 is a block diagram illustrating an example of a system for providing services, customer and task management, and exchange capability.

FIG. 2 illustrates an example listing of tasks recommended for trading.

FIG. 3 illustrates an example screen view where a service provider may purchase customer tasks which other service providers desire to sell or trade.

FIG. 4 illustrates an example service provider scheduling tool.

FIG. 5 illustrates an example scheduling screen.

FIG. 6 illustrates an example task management screen with details about a task.

FIG. 7 illustrates an example of a weekly calendar showing tasks to be performed by a service provider during a time period.

FIG. 8 is a flowchart illustrating of an example method for task exchange.

FIG. 9 is block diagram illustrating an example of a computing device that may be used in task exchange.

### DETAILED DESCRIPTION

Reference will now be made to the examples illustrated in the drawings, and specific language will be used herein to describe the same. It will nevertheless be understood that no limitation of the scope of the technology is thereby intended. Alterations and further modifications of the features illustrated herein, and additional applications of the examples as illustrated herein, which would occur to one skilled in the relevant art and having possession of this disclosure are to be considered within the scope of the description.

A technology is described for efficiently providing access to services via a networked computer system. More accurate and efficient access to services may commoditize services not traditionally commoditized in the past by allowing the services to be priced and delivered in a more uniform fashion. While access may be provided for any of a nearly limitless number of services provided by service providers, examples of commoditization of services may be applied to many areas including various yard and home services, such as: lawn mowing, lawn fertilizing, basic home repairs, painting, cleaning, gardening, small appliance repair, etc. A service provider can be any service provider, contractor, service contractor, service group, or service supply entity that provides a service to a customer.

This technology may allow a user to select a service or task (e.g., lawn mowing) to be purchased electronically, and a user interface on a client device can present choices to the customer that include task parameters and other details about the service. These service parameters can be used provide efficient commodity-like pricing. The service parameters may include task details or variables that affect pricing and other factors for the task. In a lawn mowing example, parameters may be collected from a customer that include: lawn shape and size, length of grass, type of grass, physical location, quality of service provider desired, need for repeat service, etc. The pricing of the service or task may be a fixed price that is calculated using existing facts about the service and statistical data known about task prices in a geographical area, etc. With iterated services and sufficient service provider and customer feedback, the pricing can become more accurate over time such that each task may become more like a standard unit of work that is priced with increasing accuracy. The terms service and task may be used interchangeably in this description.

Commoditized tasks purchased by a customer through this technology may be matched with one of a plurality of service providers who have schedule availability to perform the task. Customers may have the opportunity to select preferred service providers from a list of available service providers, but the selection of a service provider is optional. A customer may be encouraged to allow the service provider to be assigned automatically using a computing device, and the customer may be encouraged not to select a service provider through various pricing and other inducements. As the services become more commoditized, then the service providers become more easily interchangeable. This may provide an experience similar to a customer's experience in a retail setting where the customer is more interested in the quality of the goods received than which individual made the goods being purchased.

Service providers can be matched to customers on the basis of a number of additional parameters identified by the service providers and these parameters may include: shortest distance to customer, higher schedule availability, matching skill level, quality level desired, and other parameters. The value provided to service providers by this technology may be increased by providing more customers, assigning customers situated closer together, automated pricing, back office accounting and management functions, and other ways that improve service provider efficiency and/or boost service provider revenues.

Using a commodity approach can simplify the service purchase process and can make buying services more analogous to buying tangible goods through a retail store. Detailed methods may be used to compute a fair market pricing for the service based on customer provided specifications about the service to be performed. The fair market pricing can allow a fixed price to be presented to the customer, at the point of sale, and allow the customer to complete a transaction immediately.

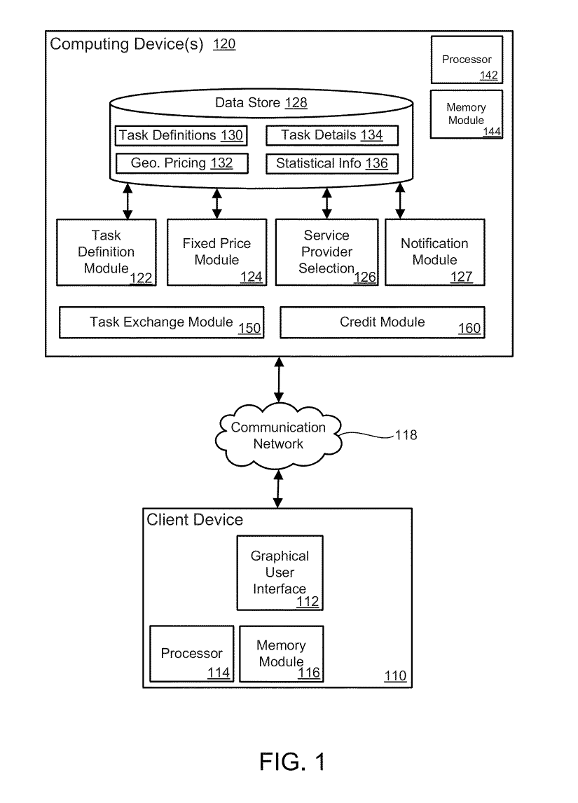

As illustrated in FIG. 1, a system can be used for delivering, pricing, assigning, managing and exchanging tasks. The system may include a client device 110 through which a user can access information related to tasks and customers over a communications network 118. The communications network can be a local area network (LAN), wide area network (WAN), or the internet. A graphical user interface 112 can be provided to the user using the client device 110 to access the task, customer, and related information located on a separate computing device 120. A client device 110 with a graphical user interface 112 may be used by either a service provider or a customer.

Parameters for a task that the customer desires to be performed can be received by the graphical user interface 112 of the client device 110. For example, the customer may type, speak, write, or select task parameters that the client device 110 can capture. Payment for the task selected by the customer may also be supplied via the graphical user interface. In one example, payment via a credit card or debit transaction is collected before the task is assigned to a service provider for performance. The client device may include a processor 114 and a memory module 116. A client device 110 may be a device such as, for example, a desktop computer, a laptop, a tablet, a mobile device, a television, a cell phone, a smart phone, a hand held messaging device, a set-top box, a gaming console, a personal data assistant, an electronic book reader, heads up display (HUD) glasses, or any device with a display that may present the graphical user interface 112.

The parameters for a task collected by the client device 110 can be sent to a computing device 120. The computing device 120 may be provided with modules for providing and managing tasks and customers. Additional related functions for communication, fixed pricing, service provider selection, task exchange, and task valuation can also be provided, as will be described later. The computing device 120 may be a single server, a distributed server environment, a server farm, or any computing device or group of computing devices that may service requests from other computing devices or programs. In addition, the computing device may include one or more processors 142 and memory modules 144.

The parameters that are requested from the customer can be collected and used by a task definition module 122. The task definition module 122 can also obtain a task definition for a task which describes task details to be performed for a customer. In addition, the task definition module 122 can access the task definitions 130 located in the data store 128, and the task definitions may include specific definitions of what procedures are going to be undertaken for a task. For example, the task definition can define a mowing job as: 1) cutting grass and 2) blowing loose grass off sidewalks. The task definition may also include a question template to send to customers to obtain the factual task parameter information that is desired to be captured from the customer about a task type. The customer's replies and specific factual data collected in response to the questions about tasks can be stored in the task details 134 data store. The data store 128 may refer to any device or combination of devices capable of storing, accessing, organizing, and/or retrieving data, which may include any combination and number of data servers, relational databases, object oriented databases, simple web storage systems, distributed storage systems, data storage devices, data warehouses, flat files, and data storage configuration in any centralized, distributed, or clustered environment. The storage system components of the data store may include storage systems such as a SAN (Storage Area Network), cloud storage network, volatile or non-volatile RAM, optical media, or hard-drive type media.

A fixed price for a task may be determined based on the parameters collected about the task. Statistical price data for tasks may also be used in calculating the fixed price for a task. As mentioned earlier, the fixed price is the fee under which a service provider is expected to perform the task for the customer after the service provider has received the task assignment. In one example, the service provider may simply work on tasks automatically assigned to the vendor's schedule, or in another example, the service provider may choose to approve work assignments in advance of scheduling. A significant portion of the retail fixed price charged to the customer can be paid to the service provider and a smaller portion of the fixed price may be retained by the entity operating the technology described in this description. For example, the fixed price can be calculated using a fixed price module 124 to set a task price for the task based on the task details and statistical price data identified in the statistical information 136 data store. The fixed price can be calculated, in part, using the task details 134 provided by the customer, as stored in the data store 128. These task details may include one or more of the following details: time since last service performed, square dimensions of project, current state or quality of project, desired state or quality of project, number of hours service may be performed, distance to be traveled, number of units to be transported, average amount of time similar jobs have historically consumed, average cost of parts similar jobs have historically consumed, number of levels or stories of a structure, number of rooms in a structure, square dimensions of a structure, the presence of exterior improvements such as a swimming pool, hot tub or basketball court, the desired start date, the desired completion date, whether a specific time or an approximate time is desired for performance of the service, the number of legal steps required by law, the grade or style of materials used, the frequency of recurrence, the depth or quantity of material to be moved or removed, the linear dimensions of project, etc.

Additional input parameters may also be obtained automatically from third parties. For example, a house lot size, square footage of the house, number of bedrooms and bathrooms, and related real property information can be obtained for a real estate information vendor. Similarly, mapping data and address correction data can be obtained from a mapping information vendor. Weather data can be obtained (e.g., for snow clearing predictions) including snow accumulation hourly actual measurements along with future predictions, temperature and humidity for estimating snow ablation from a weather information source.

Service provider feedback about customers and tasks can help refine task pricing. In some cases, there may be unexpected aspects of the tasks that occur with certain customers or certain types of tasks. For example, edging a customer's lawn may be more difficult the first time where the customer has a very overgrown lawn. Customer feedback about service providers (quality, timeliness, speed, etc.) may also be used to refine the method of matching service providers with tasks. In addition, customer feedback can also be used in refining the task pricing.

As discussed, a service provider may be selected by the technology from among the plurality of service providers to perform the task. The service provider selection can take place using the service provider selection module 126. Criteria for selecting a service provider may include using at least one of the following: a distance between the service provider and customer, time slots made available by the service provider, a skill level of service requested, previous performance feedback of the service provider from prior customers, quality tier of a service provider, etc. Other criteria or metrics about service providers may also be used in selecting a service provider, as desired.

The customer and the service provider can be notified of the service provider selection using the notification module 127. In one example, the notification module may prepare a web page or a web application page to be sent to the customer. Alternatively, a notification can be sent through the graphical user interface 112 on the client device 110 using an application on the client device 110. Other types of notifications may include: emails, instant messages, text messaging, or any other message type that can be received by the customer. Once the service provider has been selected, then the service provider can be scheduled to perform the task. More specifically, the task can be added to an available time slot on the service provider's calendar, and the customer can be notified of the scheduled task time. The notification module can also prepare other network pages, web pages, or web application pages to communicate other information to the client device 110.

In one configuration, the technology may allow just a limited number of service providers per market. A market may be a geographical market or a specific task type in a geographical area. Each service provider may be notified that as long as the service provider is willing to perform the work received by the service provider from the system, the service provider can continue to participate. This may encourage service providers to quickly sign up for markets the service provider services, so the service provider does not lose out on the possibility of new customers received through the technology. Additional service provider slots in a given market might be made available as customer demand for services in a given market begins to exceed service provider supply.

The system illustrated by FIG. 1 can also provide tools to a service provider for: managing the service provider's customers, managing the service provider's team members, monitoring jobs and schedules, managing finances, finding new customers and other service provider related functions.

Some existing services for referring a service provider to a customer take input from customers and pass the customer information along to the service provider in the form of a lead. The service providers can then bid on the task and the customer is able to select from multiple bids. Such approaches have the customer return to the website and make an additional decision as to which of the many service providers who have bid the customer would like to use. While a bidding system is useful for connecting a service provider to a customer, the overall bidding process is slow and cumbersome. Furthermore, existing services typically do not act as a payment broker to give the customer control over payment to the services provider based on quality of work performed.

### Task Valuation

Once tasks and services for customers exist within the technology environment, a value may be placed on the task and/or customer within the environment. The task may be valued based on a plurality of factors related to the service provided. One example valuation factor may be the fixed price of the task paid each time the task is performed for the customer. Since the one time price paid for completing a task is not the only measure of a task's value, other task value measures can be considered. Another factor may be the task frequency because a more frequently performed task is likely to increase a task's value as compared to a less frequently performed task. The task may also be valued based on the distance of the task from the service provider's home base or defined geographic area. A home base may be any defined location that the service provider considers to be a starting location from which labor, materials, and machines can be dispatched to perform a task. Where a customer is a comparatively long distance from the service provider's home base or geographic service area, then the value to the service provider may be lower. Customers closer to the service provider may be rated as a higher value to the service provider. In one example, this distance valuation may be performed using a distance weighting value assigned to the task or the customer.

Tasks may be valued based on a distance of a task from another task owned by a service provider or the distance of a task from every other existing task. For example, tasks that are located on a route already being serviced by a service provider may be more valuable to the specific service provider because they can be serviced by a service provider more easily. In contrast, tasks that are not near a route or geographic area being serviced by any service provider may be of lower value to service providers.

A further valuation method may be a customer value determined based on a group of fixed price tasks purchased by the customer and the frequency at which each task is being provided. Value can be assigned to individual tasks that have been purchased by the customer and the combination value of these task values can be aggregated. This aggregated value for multiple tasks can provide the total value of the customer within the system.

The task valuation may result in a credit valuation being associated with the task and/or customer. This credit valuation can be a private currency valuation, a government currency (e.g., dollars, pounds, etc.), or credits and can represent a value of the task or customer within the technology system. The number of credits associated with a task may take into account the items discussed earlier, including: the task price, task recurrence, distance from a service provider, and other factors, etc. For example, such credit valuations may be applied using a credit module 160 to set a credit value for the task based on the task price and task frequency. The credit module 160 may also set the credit value based in part on a distance of the task from the seller service provider (e.g., contractor) or the buyer service provider (e.g., contractor). The credit module 160 may set the credit value of a task based in part on additional attributes of the task such as: distance of the task from any service provider, a distance of the task from any nearest existing task or a distance of the task from a scheduled nearest task for a service provider. The credit module may also set the credit value of the task based in part on a combination of a geographic distance and time proximity of the task as compared to a scheduled task that a service provider already has received. For example, a top ranked task for a buyer service provider (or top credit value task) for trading may be a task which is near to an already scheduled task that is either immediately before or after an already scheduled task on the buyer service provider's time schedule. The credit valuations for a task may be recorded in a service provider's account within the system.

In an example, a first task can have a higher value as compared to a second task when the first task has a higher price per completion instance as compared to the second task and/or the first task is being performed more frequently. As an example, a large lawn may have a higher price ($100) due to the size of the lawn and the lawn may be mowed once a week. Whereas, a small lawn ($30) may be mowed just once a month. Thus, an example of relative value may be that the large lawn is worth 4000 credits as a task and the small lawn is worth 300 credits. In a related example, if the small lawn ($30) is being mowed each week then the value of the small lawn may be 1200 credits and if the large lawn is being mowed just once a month, then the value of the large lawn maybe 1000 credits (i.e., less than the small lawn).

In another example valuation, an individual task within the system can be assigned a credit value based directly on the task's fixed price. For example, a customer with a $50 task performed once a week may be worth 1 credit and a $50 task performed once a month may be worth 0.25 credits. In contrast, a $50 task performed just once may only be worth 1/50 of a credit or 0.02 credits or even less. The credit valuations may be normalized throughout the system on the average task value, mean task value, or another task value measure. Of course, such credits may be scaled by a factor of 10, a factor of 100 or another factor as desired. This valuation allows the technology to discriminate between one time customers, less frequent customers, and repeating customers. When distance is a factor in valuation, the credit price may be increased or decreased according to a percentage value or weighting that represents distance. For instance, if the mean customer distance for most service providers is 10 miles but a specific customer is only 7 miles away from a selected service provider, then the credit value for that customer may increase 30% or another percentage as selected by the system.

Another example of a credit valuation factor may include a weighting value applied to the task based a computed quality value of the customer. Customer quality can be determined using criteria like: how many times the customer historically has had their lawn mowed using the system (e.g., a high number may indicate a more stable customer and therefore the customer may be worth more in credits); how frequently does the customer complain about services performed; how many different services the customer has ordered; a customer's credit score; etc.

### Exchange

Once tasks and customers have been valued, service providers may be able to trade tasks and customers based on credit valuations. FIG. 1 illustrates that a task exchange module 150 can be provided to exchange tasks and customers with other service providers. More specifically, the task exchange module 150 can offer the tasks for exchange via an electronic exchange interface and enable an exchange of one or more tasks between a seller service provider and a buyer service provider based on a credit value. In addition, tasks and customers may be sold to the managing entity controlling the task exchange module 150 and such tasks and customers can be resold to other service providers by the managing entity. The managing entity may also use a bid-ask spread for tasks and customers that the managing entity transfers. This means that for an equivalently valued customer or task, a service provider may typically receive a smaller payment to sell the task or customer than the service provider will pay to buy an equivalent task or customer through the technology.

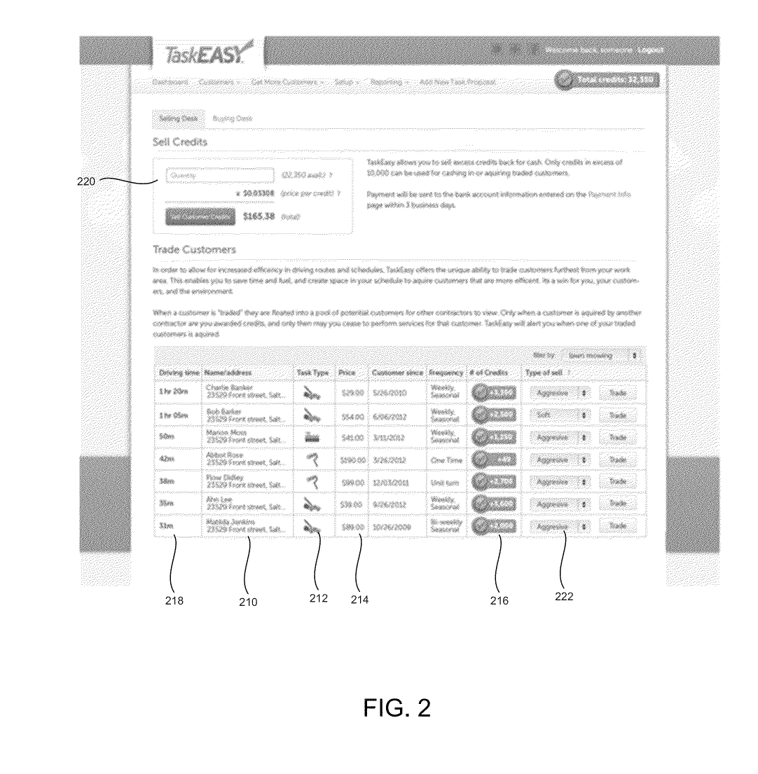

A trading interface may present a customer list to a service provider, which provides a list of tasks associated with the service provider through the technology. This listing can be a prioritized list of customers displayed to the seller service provider which may provide recommendations for exchange by the service provider. FIG. 2 illustrates an example listing of tasks that illustrates: customers 210, tasks 212 with task types, a task performance price 214, and a number of credits 216 associated with each task. The tasks may also be ranked according to distance values 218 as compared to the service provider. The prioritized list may be prioritized based on a task's distance from the seller service provider's home base or proximity to other tasks performed by the seller service provider. In other words, tasks the service provider is likely to want to trade away due to a greater than average distance of the customer from the service provider can be highly ranked. Alternatively, the tasks can be ranked based on the task price, a credit value, or another task related attribute.

FIG. 2 also illustrates that the type of trade 222 to be performed can be selected. A hard or aggressive trade can be selected when the service provider wants to sell the task or customer for credits in the system without the customer permission. A hard trade is trade where the service provider would rather risk losing the business, particularly with a chance that he might get credits in exchange for the trade, rather than continue to perform the service for what might be a very inconvenient customer. A soft trade can be selected if the service provider wants to trade the task or customer for another similar task or customer. In a soft trade, the task or customer may also be held in escrow until the customer is notified about the trade or until the customer approves the trade. The system can also hold the task or customer in escrow until the service provider selling the task or customer has approved of the trade with another service provider. A soft trade is a trade where the service provider would rather have to continue to perform work for that customer rather than risk losing the business completely.

A real time bidding (RTB) system can also be put in place for trading tasks and customers. Service providers can place their tasks or customers into a real time auction and set a minimum price and a time that the bidding ends. Other service providers can then bid on the task or customer based on the details presented to a purchaser about the task. The bidding can be priced in system credits. In one configuration, the system can provide a recommended credit purchase price so that a reasonable starting bid price can be established or an early buy-out price can be set by the service provider.

For some trades, the system can take a percentage of a credit value for a task or customer transfer from one service provider to another. For example, a task may be valued at 1000 credits based on the task performed and task frequency. However, the system may pay the selling service provider 850 credits for transferring the customer to another service provider. Whereas the purchasing service provider may pay 1000 credits for purchasing the customer through the system from the selling service provider. Thus, the task exchange module 150 (FIG. 1) that is enabling the trade can collect 150 credits for the work performed in executing the task and/or customer trade. In the case of a completed auction transaction, the system can take a pre-defined percentage of the auction price. Alternatively, a fixed commission can be collected by the system for task and customer exchanges using either sales or auctions.

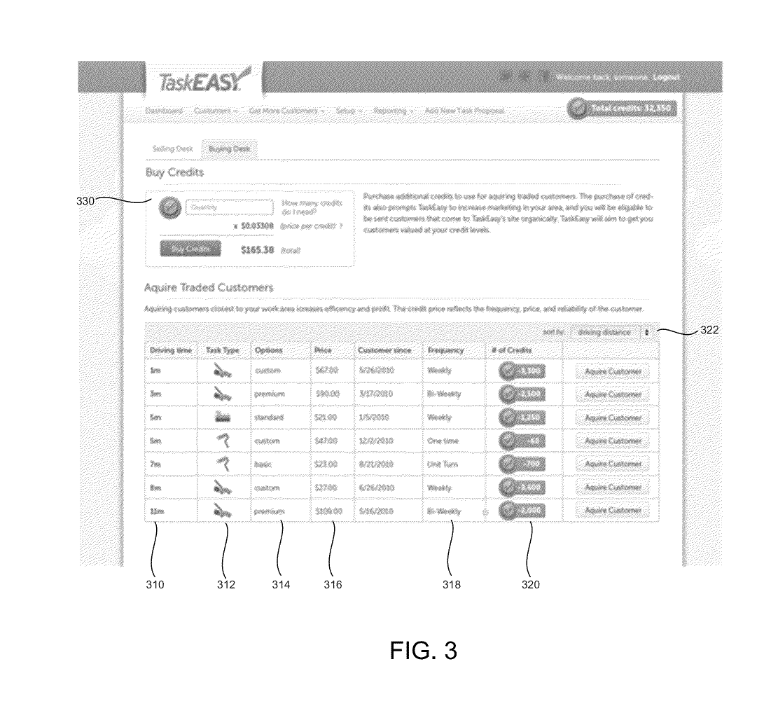

The existence of a private currency system with credits allows service providers to buy and sell tasks, customers, marketing campaigns, and other transferrable items of value being traded within the system. If a service provider desires to trade and purchase tasks or clients but does not have enough credits within the system, then the service provider can purchase credits with money (i.e., legal national tender) from outside the system. FIG. 3 illustrates that additional credits can be purchased through a credit purchasing graphical user interface 330. Additional credits can be used for acquiring customers being traded away by other service providers. Credits can also be used to supplement a service provider's existing credits for task trades and allows service providers to more easily trade clients even where the service provider's own clients are not as valuable as the new clients the service provider desires to obtain.

FIG. 3 further illustrates an example screen display where a viewing service provider may purchase tasks and customers which other service providers desire to sell or trade. The list of possible trades may display task related information such as: how close the task is to the potential purchaser 310, the task type 312, task options 314, task price 316, task frequency 318, and other related task and trading information. The cost for purchasing a task or customer in credits 320 can also be listed.

The list illustrated in FIG. 3 can be a prioritized list of customers presented to the buyer service provider that a seller service provider desires to sell or exchange. The listing of tasks or customers for sale may be sorted by various criteria 322 selected by the end user. The prioritized list can be prioritized based on a distance from the buyer service provider's home base or from a proximity to other tasks performed by the buyer service provider. In addition, prioritization can be based on the credit value for the task. Further prioritization criteria can include sorting the task listing by driving distance, task price, number of credits, or other criteria.

Another form of filtering may use a system filter that allows buying service providers to view just those tasks which are in the buying service provider's defined work area or within a certain range of the service provider. In addition, purchasable customer may only be presented to service provider that represents an improvement in any of a number of relevant parameters over existing customer arrangements the service provider currently has. For example, the improvement may be a customer who provides an improvement in distance. The improvement in distance may be an improvement in distance from the service provider, from the service provider's last job, or another measurement point, and so forth. In other words, if a given service provider is, for instance, sub-optimally located farther away from a given available task, then the service provider may not even be able to see that task as being available for purchase. Other types of improvement may include profit improvement, bundled task improvement, task size improvement, or other improvements that help the service provider's business.

Accumulated credits may also be sold 220 as illustrated in FIG. 2. The accumulated credits from selling customers, submitting customers to the system, or other credit accumulation can be traded for money (i.e., legal tender) that can be transferred to the service provider's bank account at a third party bank. The ability to convert tasks and customers into credits and money is beneficial to service providers because the conversions help the service providers trade tasks and customers to increase the service provider's profitability and liquidate tasks and customers as desired.

In one trading example, the service provider may choose to initiate a trade or sale of a customer, who is the greatest distance from the service provider's defined territory, to other service providers. The ability to trade customers between service providers can allow the service providers to service more customers in the same time period because the service provider can trade away customers who are a long distance from the service provider's geographical area or base location. As a result, the service provider may spend less time on travel and travel expenses which can increase the service provider's profitability. In a similar example, a service provider may want a majority of the service provider's customers to be in smaller geographic radius but the value of the service provider's clients may not support such trades. By purchasing credits and trading some less valuable tasks and clients, then this goal may be realized. The service provider may then become more profitable as a result of such trades and this in turn helps the service provider realize a return on his initial business investment.

In one configuration, bulk trades may be available and a service provider may purchase all or part of another service provider's book of business. The valuation of a large number of tasks or customers may increase the overall value of the grouping because the grouping represents a significant part of a business portfolio. Thus, the exchange module 150 (FIG. 1) can be used as a fractional or whole business broker for the service providers.

Another example of what a service provider might purchase with credits is training about the service provider's service specialty (e.g., video training, live training, etc.), business training, or training on how to effectively use the system. The purchase of credits by a service provider in a geographical area can be used as an indicator that marketing can be started in the service provider's area. For example, geographically targeted web and print marketing can be provided or increased based on the number of service providers in an area and the number of credits purchased by service provider's in a geographic area.

Service providers can also earn credits by undertaking particular operations within the system. Credit earning opportunities can include the opportunity for a service provider to earn credits by taking steps to enroll as a service provider in the system, providing the service provider's contact information, passing a background check or credit check, verifying proper insurance, supplying a valid bank account for payments, linking an account to a social media account, linking an account to a cell phone number, adding a task category the service provider is willing to perform, making blocks of service provider scheduling time available, trading customers outside the service provider's work area, referring customer contacts to the system, purchasing tasks and customers, or other actions performed in the system. Due to the importance of customers to the system, bonus credits may be given to service providers who import customers into the system. For example, a service provider can import an email or address book or enter customer contact information by hand. Bonus credits can also be given for positive behavior of the service providers, such as getting good ratings from customers.

The service provider may be able to earn credits for performing marketing to bring other contacts into the system. For example, the service contractor can earn credits for sending: marketing emails, social media communications, postings, or other invites to contacts or friends to join the system. Credits can also be provided to a service provider when invitations result in a customer actually joining and ordering a task, even a task where the particular service provider does not provide the final service or the customer comes from an area where the referring service provider does not work. Credits can also be awarded to the service provider for ordering marketing materials such as: physical door hangers that market the system's services, t-shirts; signs or other promotional material.

Service providers may also spend credits on marketing programs provided by the system. The service providers may spend credits for marketing programs executed by the technology and receive customers in return for the credits spent. For example, an internet marketing program may generate new customers that are assigned through the system. Thus, a service provider may pay credits for a block of internet marketing that is expected to generate an estimated number of customers. Credits may also be earned when one service provider refers another service provider to join the system. When the referred service provider joins or takes specific actions within the system, then the referring service provider may be granted credits. Purchasing a marketing program can also provide credits as a reward for participation.

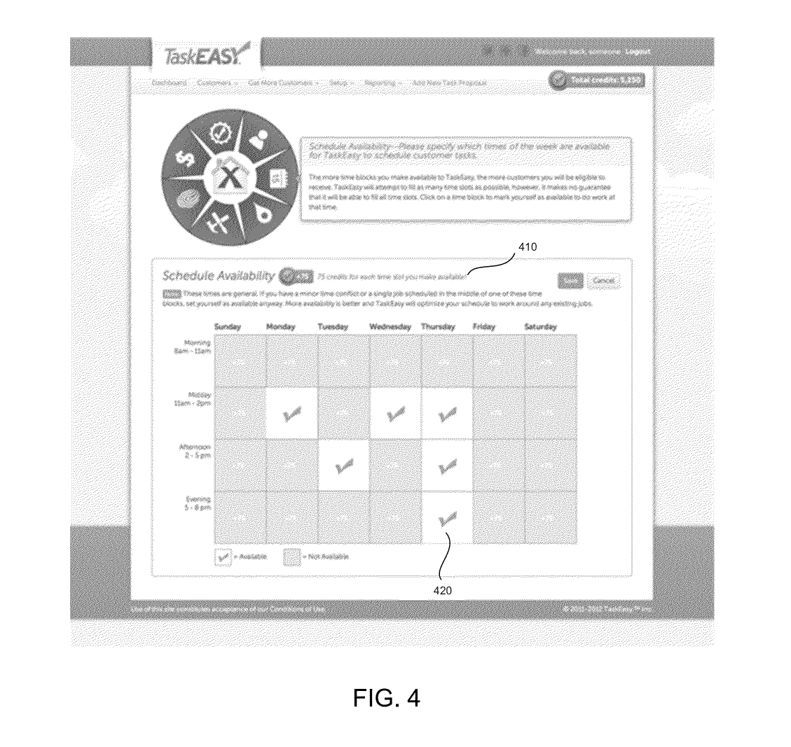

FIG. 4 illustrates a service provider scheduling tool where a service provider selects blocks of time 420 when the service provider can be available to work on tasks for customers. As a service provider makes blocks of time available for tasks, the service provider can receive credits 410 for making that time available. For each block of time available, a fixed amount of credits can be paid to the service provider. For example, a service provider may receive 75 credits per block of time allocated. In another configuration, the service provider may receive an increasing amount of credits per block allocated as the service provider increases the number of blocks in the system. Increasing the credits granted as the number of time blocks allocated by the service provider increases may encourage service providers to allocate more of their time through the system. In an example, the first block of time allocated may pay 70 credits, the second block 72.5 credits, the third block 75 credits, and so forth.

Trading of customers can also be an inducement to a service provider to contribute the service provider's entire existing customer portfolio. When a service provider submits a defined number of the service provider's customers to the system, then a specific number of discounted or free trades can be given to the service provider. The service provider can then use the defined number of task or customer trades at a defined value to trade their customer's with other service providers for contributing their customers.

The ability for service providers to trade customers using an automated valuation allows the service providers to feel fairly treated during trades. A computerized valuation of a task or customer can provide a more uniform valuation of the task value or customer value each time a valuation is made. This automated valuation can result in faster trades and avoid haggling between the service providers. Since the service providers are trading through an electronic system, the number of service providers with which the selling service provider can trade is increased, and a larger trading pool helps ensure that the trading prices are more likely to be fair.

Service providers may use accumulated or purchased credits to purchase customers or tasks entering the system, where those customers have no pre-existing relationship to a service provider. Such customers may enter the system using a general marketing program that is not associated with any specific service provider. Paying credits for such new tasks and customers may provide the service provider with a priority placement in a queue for receiving new customers entering the system without a service provider association.

In one trading configuration, the service provider can trade the customer to another service provider for a customer of similar value without transferring credits (i.e., without the valuation above), or the customer may choose to trade multiple smaller value clients for one higher value client. Being able to trade tasks and customers without trading credits or money provides a bartering system for trading customers based on the service provider's perceived relative value of tasks and customers or another subjective valuation. This bartering method allows the service providers to efficiently exchange tasks or customers.

This technology can also assist service providers with individualized online marketing programs. For example, web pages or landing pages can be hosted that a service provider can refer clients to and these web pages may also provide a user interface for the customer to be become enrolled in the system and purchase tasks at a fixed fee rate. Of course, a web site or a domain name the service provider currently is using can also be interlinked to service provider's landing page and similarly promoted. Service providers can get credits in the system for customers who sign-up to purchase tasks through the service provider's co-branded website. Then the service provider can service the new customers or trade the new customers with other service providers.

Service providers can also be linked to the system through social media web sites. Scripted postings, stock status postings, news, special promotions, special events, tweets, instant messages, and similar marketing material can be sent to the service provider to post on social media accounts or otherwise use for sending messages to customers, potential contacts, and friends. Similarly, a service provider's social media account can follow a marketing account associated with the system. This marketing account can provide materials the service provider can post that are interesting and have a high re-posting value to the service provider's friends.

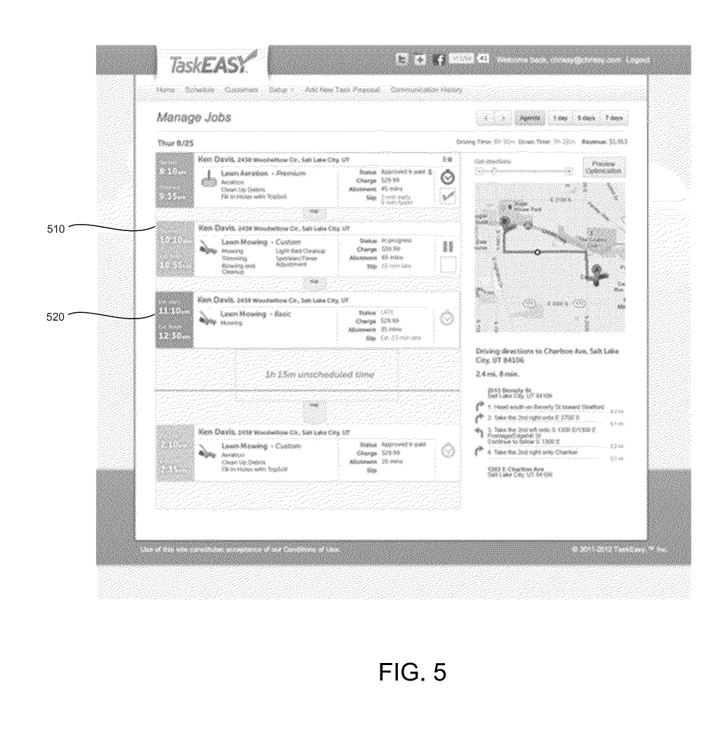

FIG. 5 illustrates an example scheduling screen that may be displayed on a client device or a mobile device. A service provider can access and view the service provider's schedule 510 of tasks purchased by customers and information related to those tasks. Scheduling and related information such as a task details, charges, start times, stop times, previous tasks, following tasks, and driving directions can be displayed. Using this dynamically changing schedule, the service provider can identify whether the service provider is meeting expected time targets on a current task. For example, the task may have an allotted time for completion and the service provider can view whether the scheduled time target was met or exceeded. The upcoming tasks can also be seen in the scheduling list 520.

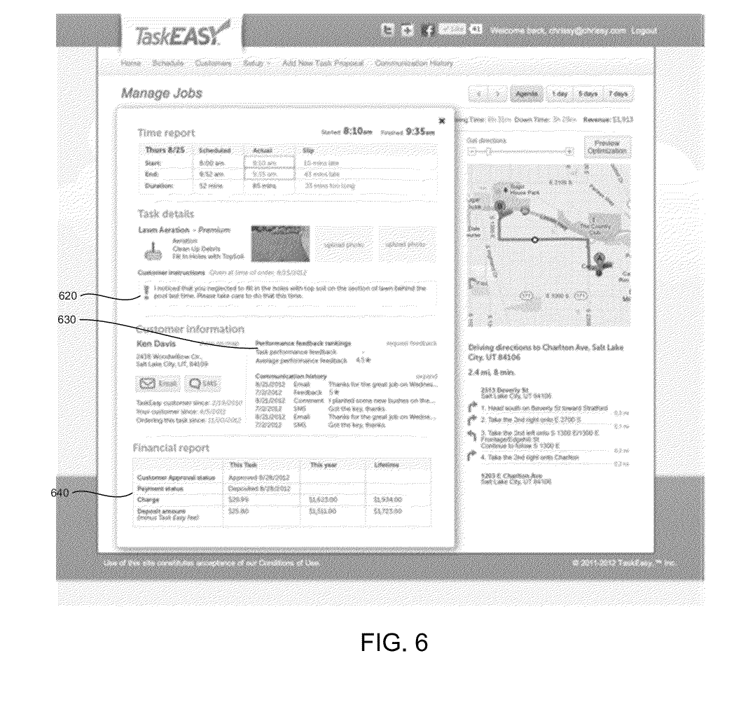

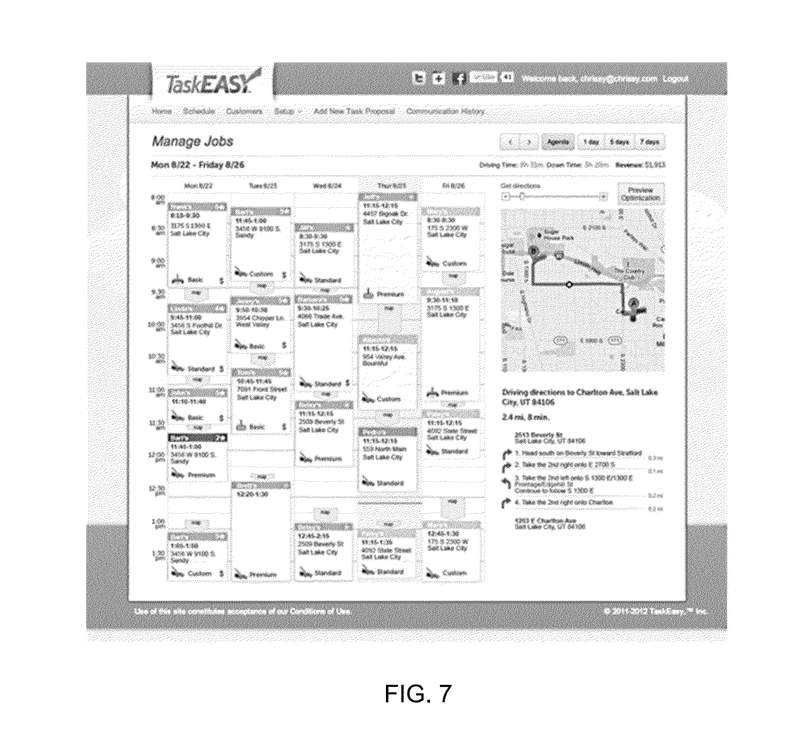

FIG. 6 illustrates an example task management interface screen with details about a task. This task management screen can include feedback from the customer 620 or similar types of comments. A rating 630 on the quality of the completed task can also be included. For example, ratings can be provided on a scale of one star to five stars or another rating scale. The service provider can view the rating for a task in order to determine whether or not to improve their service. Customers can also see the ratings of the service providers as submitted by other customers. Financial reporting 640 can also be provided to allow a service provider to view payments made by a customer along with yearly and lifetime revenue totals for a task for a customer. FIG. 7 illustrates a weekly calendar showing tasks to be performed by the service provider during a one week period.

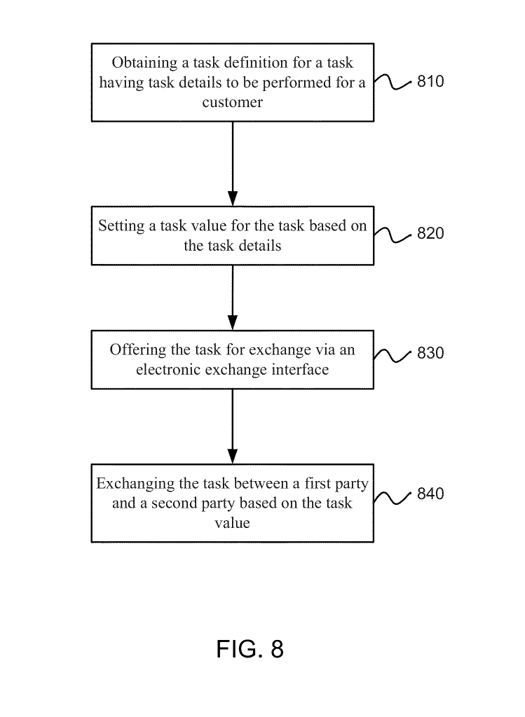

FIG. 8 illustrates a method for task exchange. An operation in the method can include obtaining a task definition for a task having task details to be performed for a customer, as in block 810. In one example, the task details may be a lawn size and a mowing frequency. In an additional example, a task definition can be defined using a task template explaining detailed task responsibilities. In the case of a lawn care treatment, the task template for one task definition may store detailed task responsibilities that are enumerated for a fertilization task, such as: 1) application of liquid lawn fertilizer and 2) application of broad leaf plant killer.

A task value for the task can be set based on the task details, as in block 820. The task value can be computed using the task details and may be combined with data tables defining prices using specific task-oriented rules, geographical area conditions, and economic conditions in light of the task details received. The rules may be configurable and the data sets used to set the task value based on the task details can be updated using statistical feedback over time. Task valuation may also be set in credits or another numerical valuation system.

The task can be offered for exchange via an electronic exchange interface, as in block 830. In addition to offering a single task to exchange, multiple tasks for a single customer can be offered for exchange or multiple tasks for multiple customers can be exchanged.

The task can be exchanged between a first party and a second party based on the task value, as in block 840. The exchange may occur by exchanging credits between the parties for tasks and customers. For example, a second receiving party may pay the first selling party with one or more credits in an electronic exchange. In another transaction, the exchange may be a barter of one or more tasks for a different group of tasks of similar or equal value. The exchange may also include a trade where a portion of the transaction is barter based and a portion of the trade is credit based. For example, the second receiving party may pay the first selling party with a task and one or more credits in the electronic exchange. The task(s) that were exchanged can be scheduled and paid for by the customers and then performed by one or more service providers who received the tasks in the exchange. If the task was already scheduled and/or paid for, the new service provider may take over the existing scheduled appointment.

As described above, a task price can be set for the task based on the task details and related statistical price data. The task price can also be used in setting a credit value for the task in an electronic exchange. One of the task details that can be used for calculating a credit value can be task frequency. Other criteria for setting a credit value for the task can be based on labor time, customer profitability, or task distance from a seller service provider or buyer service provider. This credit value can be used in exchange and trading.

Another specific attribute or detail for setting the credit value for the task can be based in part on a schedule availability of the buyer service provider to perform the task. In another configuration, setting a credit value of a task based on schedule availability can allow the credit value for the task to be set based in part on schedule flexibility for either the customer or the service provider to enable cost optimization based on service provider availability, customer availability, service provider proximity, or customer proximity. For example, credit value for a task may be set by the service provider's proximity as defined by, but not limited to: the service provider's home, the service provider's defined place of business, the service provider's last job, the service provider's next job, all of the service provider's jobs for that day, or all of the service provider existing jobs. Similarly, the credit value can be set for the task based in part on optimizable travel path for an entire group of tasks owned by a service provider.

The technology can also determine whether a task exchange is available based on the schedule availability of the buyer service contractor. If a buyer service contractor does not have available time or schedule time that matches up with a task for exchange, then the buyer service contractor may not be presented with the task. Alternatively, the task may be presented as being a good trading match based on geographical proximity or other reasons but the task may be flagged as having a conflict with another task on the service provider's schedule. This type of conflict flagging may allow the buyer service contractor to try to resolve the conflict in order to purchase the task or trade for the task.

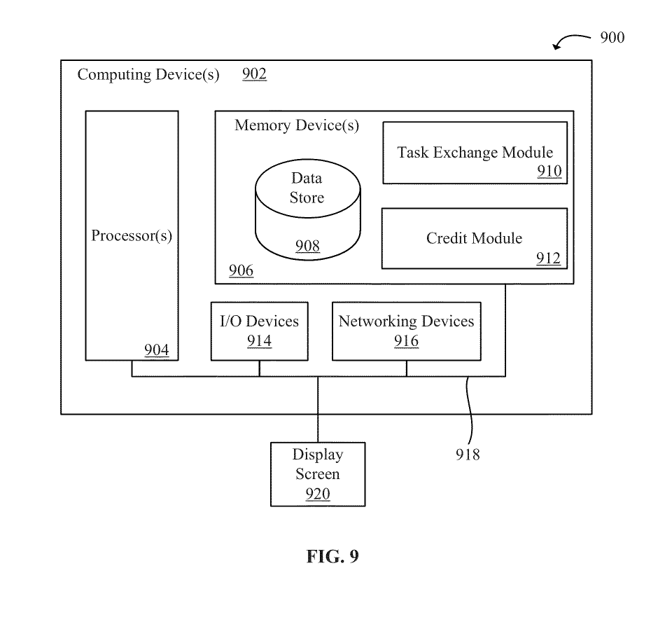

FIG. 9 is block diagram 900 illustrating an example of a computing device 902 that may be used for discovering content. In particular, the computing device 902 is illustrates a high level example of a device on which modules of the disclosed technology may be executed. The computing device 902 may include one or more processors 904 that are in communication with memory devices 906. The computing device 902 may include a local communication interface 918 for the components in the computing device. For example, the local communication interface may be a local data bus and/or any related address or control busses as may be desired.

The memory device 906 may contain modules that are executable by the processor(s) 904 and data for the modules. Located in the memory device 906 are modules executable by the processor. For example, a task exchange module 910, a credit module 912 and other modules may be located in the memory device 906. The modules may execute the functions described earlier. A data store 908 may also be located in the memory device 906 for storing data related to the modules and other applications along with an operating system that is executable by the processor(s) 904.

Other applications may also be stored in the memory device 906 and may be executable by the processor(s) 904. Components or modules discussed in this description that may be implemented in the form of software using high programming level languages that are compiled, interpreted or executed using a hybrid of the methods.

The computing device may also have access to I/O (input/output) devices 914 that are usable by the computing devices. An example of an I/O device is a display screen 920 that is available to display output from the computing devices. Other known I/O devices may be used with the computing device as desired. Networking devices 916 and similar communication devices may be included in the computing device. The networking devices 916 may be wired or wireless networking devices that connect to the internet, a LAN, WAN, or other computing network.

The components or modules that are shown as being stored in the memory device 906 may be executed by the processor(s) 904. The term “executable” may mean a program file that is in a form that may be executed by a processor 904. For example, a program in a higher level language may be compiled into machine code in a format that may be loaded into a random access portion of the memory device 906 and executed by the processor 904, or source code may be loaded by another executable program and interpreted to generate instructions in a random access portion of the memory to be executed by a processor. The executable program may be stored in any portion or component of the memory device 906. For example, the memory device 906 may be random access memory (RAM), read only memory (ROM), flash memory, a solid state drive, memory card, a hard drive, optical disk, floppy disk, magnetic tape, or any other memory components.

The processor 904 may represent multiple processors and the memory 906 may represent multiple memory units that operate in parallel to the processing circuits. This may provide parallel processing channels for the processes and data in the system. The local interface 918 may be used as a network to facilitate communication between any of the multiple processors and multiple memories. The local interface 918 may use additional systems designed for coordinating communication such as load balancing, bulk data transfer and similar systems.

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. The modules may be passive or active, including agents operable to perform desired functions.

The technology described here can also be stored on a computer readable storage medium that includes volatile and non-volatile, removable and non-removable media implemented with any technology for the storage of information such as computer readable instructions, data structures, program modules, or other data. Computer readable storage media include, but is not limited to, RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which can be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media. The term computer readable media as used herein includes communication media.

Furthermore, the described features, structures, or characteristics may be combined in any suitable manner in one or more examples. In the preceding description, numerous specific details were provided, such as examples of various configurations to provide a thorough understanding of examples of the described technology. One skilled in the relevant art will recognize, however, that the technology can be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements can be devised without departing from the spirit and scope of the described technology.

1. A method for task exchange, comprising:
obtaining a task definition having task details for a task to be performed for a customer;
setting a task value for the task based on the task details using a processor;
offering the task for exchange via an electronic exchange interface; and
exchanging the task between a first party and a second party based on the task value using the processor.

2. The method as in claim 1, further comprising offering a plurality of tasks for a single customer for exchange.

3. The method as in claim 1, further comprising offering a plurality of tasks for a plurality of customers for exchange.

4. The method as in claim 3, further comprising engaging a plurality of service providers to perform the plurality of tasks.

5. The method as in claim 1, wherein the second party exchanges a task of an equal value with the first party.

6. The method as claim 1, wherein the second party pays the first party with a task and one or more credits in an electronic exchange.

7. The method as claim 1, wherein the second party pays the first party with one or more credits in an electronic exchange.

8. The method as in claim 1, further comprising updating rules and data sets used to set the task value based on the task details using statistical feedback.

9. A method for exchange, comprising:
obtaining a task definition having task details for a task to be performed for a customer by a seller service provider;
setting a task price for the task based on the task details and statistical price data using a processor;
setting a credit value for the task in an electronic exchange;
offering the task for exchange via an electronic exchange interface; and
exchanging the task between the seller service provider and a buyer service provider based on the credit value using the processor.

10. The method as in claim 9, wherein setting a credit value further comprises setting a credit value for the task in the electronic exchange based on a task valuation using the task price and task frequency.

11. The method as in claim 9, further comprising setting a credit value for the task based on a task valuation that is based on labor time or customer profitability.

12. The method as in claim 9, further comprising setting the credit value for the task based in part on a distance of the task from the seller service provider or the buyer service provider.

13. The method as in claim 9, further comprising defining a task definition using a task template defining task details used in setting a task price.

14. The method as in claim 9, further comprising providing a prioritized list of a plurality of customers to the seller service provider as recommended for exchange and the prioritized list is prioritized based on distance from the seller service provider's home base.

15. The method as in claim 11, further comprising providing a prioritized list of a plurality of customers to the seller service provider that is prioritized based on the credit value for the task.

16. The method as in claim 9, further comprising providing a prioritized list of a plurality of customers to the buyer service provider as recommended for exchange and the prioritized list is prioritized based on distance from the buyer service provider's home base.

17. The method as in claim 16, further comprising providing a prioritized list of a plurality of customers to the buyer service provider that is prioritized based on the credit value for the task.

18. The method as in claim 9, further comprising calculating a customer value based on a plurality of tasks purchased by the customer.

19. The method as in claim 9, further comprising assigning credits to a service provider who supplies contacts to a customer exchange system.

20. The method as in claim 9, further comprising determining whether exchange of the task is available based on schedule availability of the buyer service contractor.

21. The method as in claim 9, further comprising setting the credit value for the task based in part on schedule flexibility for the customer to enable cost optimization based on customer proximity.

22. The method as in claim 9, further comprising setting the credit value for the task based in part on schedule flexibility for the service provider to enable scheduling optimization based on service provider proximity.

23. The method as in claim 9, further comprising setting the credit value for the task based in part on optimizable travel path across a plurality of tasks.

24. A system for customer exchange, comprising:
a task definition module to obtain a task definition having task details for a task to be performed for a customer;
a fixed price module to set a task price for the task based on the task details and statistical price data;
a credit module to set a credit value for the task based on the task price and task frequency;
an electronic exchange module to offer the task for exchange via an electronic exchange interface and to enable an exchange of the task between a seller service provider and a buyer service provider based on the credit value.

25. The system as in claim 24, wherein the credit module sets the credit value based in part on a distance of the task from the seller service provider or the buyer service provider.

26. The system as in claim 24, wherein the credit module sets the credit value based in part on a minimum distance of the task from any service provider.

27. The system as in claim 24, wherein the credit module sets the credit value based in part on a distance of the task from a nearest existing task.

28. The system as in claim 24, wherein the credit module sets the credit value of the task based in part on a geographic distance and time proximity of the task to a scheduled task.

29. The system as in claim 24, wherein the electronic exchange module presents a prioritized list of a plurality of customers to the seller service provider as recommended for exchange and the prioritized list is prioritized based on distance from the seller service provider's home base.

30. The system as in claim 24, wherein the electronic exchange module presents a prioritized list of a plurality of customers to the seller service provider as recommended for exchange and the prioritized list of a plurality of customers presented to the seller service provider is prioritized based on the credit value.

31. The system as in claim 24, wherein the electronic exchange module presents a prioritized list of a plurality of customers to the buyer service provider as recommended for exchange and the prioritized list is prioritized based on distance from the buyer service provider's home base or geographic center of other tasks performed by the buyer service provider.

32. The system as in claim 31, wherein the prioritized list of a plurality of customers presented to the buyer service provider is prioritized based on the credit value.
